(19) United States
(12) Patent Application Publication
(10) Pub. No.: US 2007/0129486 A1
(43) Pub. Date: Jun. 7, 2007

(54) Redispersible dispersion powders for heat insulating composite system

(76) Inventors: Heinz-Peter Klein, Mainz (DE); Michael Schottler, Bischofsheim (DE)

Correspondence Address: NATIONAL STARCH AND CHEMICAL COMPANY, P.O. BOX 6500, BRIDGEWATER, NJ, 08807-3300, US

(21) Appl. No.: 10/577,761

(22) PCT Filed: Oct. 4, 2004
(86) PCT No.: PCT/EP04/11044

§ 371 Date: Jan. 29, 2007

(30) Foreign Application Priority Data
Oct. 31, 2003 (DE) 103 51 334.5

(51) Int. Cl. C04B 24/26; C08L 33/00

(52) U.S. Cl. 524/563; 524/556

(57) ABSTRACT

The present invention relates to the use of water-redispersible dispersion powders based on one or more copolymers which are stabilized with at least one protective colloid in the production of composite thermal insulation systems, wherein the copolymer or copolymers contain(s) monomers containing carbonyl groups.

The invention relates to the use of water-redispersible dispersion powers based on copolymers containing carbonyl groups as binders in composite thermal insulation systems.

Homopolymers and copolymers have for many years been used in the building sector as polymer additives for hydraulically setting systems, preferably in the form of dispersion powders. An overview of the action of dispersion powders in such building materials may be found in the Tonindustrie Zeitung TIZ 9, 1985, p. 698. The addition of dispersion powders enables properties of hydraulically setting systems, e.g. abrasion resistance, tensile bending strength, scratch resistance and, in particular, adhesion to critical contact areas such as sintered tiles and plastics, to be significantly improved. Polymer foams, e.g. in the form of expanded polystyrene boards, are used especially in composite thermal insulation systems to achieve the desirable thermal insulation effect. Adhesive bonding of the polymer foams (thermal insulation materials) is effected by means of trowelling compositions which frequently contain dispersion powders based on homopolymers and copolymers without functional groups. A disadvantage is that adhesive bonds formed by means of such trowelling compositions have relatively low tensile bond strengths between trowelling composition and thermal insulation material, in particular after exposure to water (wet adhesion). However, it would be desirable for thermal insulation adhesives to have tensile bond strengths which are at a constant and high level regardless of the climatic stresses on the adhesive bonds, i.e. dry or wet.

EP 1 148 038 describes the use of water-redispersible polymer powders based on vinyl ester polymers in building adhesive compositions, including in thermal insulation adhesives. The polymers contain hydrophilic comonomers having, for example, carboxyl, amide, nitrile and sulfonic acid groups in amounts of from 0.2 to 1.5% by weight, based on the total weight of the polymers. The use of the hydrophilic comonomers gives the building adhesives mentioned improved tensile bond strengths, even after wet storage. The use of hydrophobic comonomers having functional groups is not mentioned in this cited patent.

EP 0 894 822 claims a crosslinkable, water-redispersible powder composition which is based on water-insoluble polymers having functional (crosslinkable) groups, water-soluble polymers and crosslinkers present in salt form. The water-insoluble polymers contain functional comonomers having substituents selected from the group consisting of aldehyde, keto, epoxide, isocyanate, carboxylic anhydride and aziridine groups. The preferred comonomers all have a poor solubility in water and can therefore be classed as hydrophobic. Indications of the use of the powder composition claimed in composite thermal insulation systems are not given in this cited document.

It is therefore an object of the invention to provide a water-redispersible, film-forming dispersion powder having improved adhesion properties, especially in respect of wet adhesion, for use as binder in composite thermal insulation systems.

This object has been able to be achieved by the use of a water-redispersible dispersion power based on
one or more copolymers which comprise monomers having one or more carbonyl groups and are stabilized with at least one protective colloid.

Preferred monomers containing carbonyl groups bear aldehyde and/or keto groups. The use of carbonyl-containing monomers which are derived from α,β-unsaturated compounds (terminally unsaturated) have been found to be particularly useful.

Preferred monomers are α,β-unsaturated (C₃-C₂₅)-aldehydes of the formula (I),

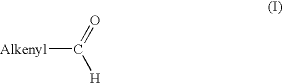

where the alkenyl radical is a monounsaturated or polyunsaturated linear or branched radical having from 2 to 24 carbon atoms or

α,β-unsaturated (C₄-C₂₅)-ketones of the formula (II),

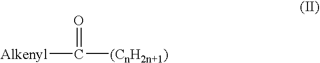

where n is an integer from 1 to 12 and the alkenyl radical is a monounsaturated or polyunsaturated linear or branched radical having from 2 to 23 carbon atoms or

α,β-unsaturated compounds of the formula (III),

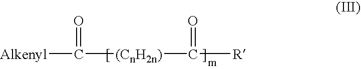

where m is an integer from 1 to 10 and the values of n in each unit m are each, independently of one another, an integer from 1 to 12 and Alkenyl is a monounsaturated or polyunsaturated linear or branched radical having from 2 to 24 carbon atoms and R′ is H or a (C₁-C₁₂)-alkyl radical or

α,β-unsaturated compounds of the formula (IV),

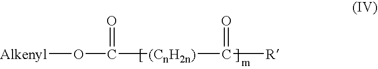

where m is an integer from 1 to 10 and the values of n for each unit m are each, independently of one another, an integer from 1 to 12 and Alkenyl is a monounsaturated or polyunsaturated linear or branched radical having from 2 to 24 carbon atoms and R′ is H or a (C₁-C₁₂)-alkyl radical or

α,β-unsaturated compounds of the formula (V),

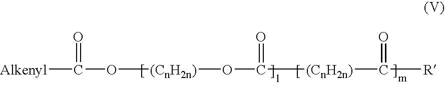

where I is 0 or 1, m is an integer from 1 to 10 and the values of n for each (CₙH₂ₙ) group are each, independently of one another, an integer from 1 to 12 and Alkenyl is a monounsaturated or polyunsaturated linear or branched radical having from 2 to 24 carbon atoms and R′ is H or a (C₁-C₁₂)-alkyl radical or

α,β-unsaturated compounds of the formula (VI) or (VII),

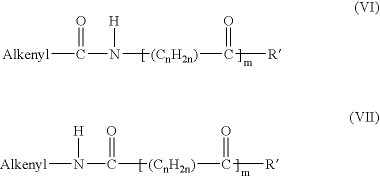

where m is an integer from 1 to 10 and the values of n for each (CₙH₂ₙ) group are each, independently of one another, an integer from 1 to 12 and Alkenyl is a monounsaturated or polyunsaturated linear or branched radical having from 2 to 24 carbon atoms and R′ is H or a (C₁-C₁₂)-alkyl radical. In the formulae (II) to (VII), the (CₙH₂ₙ) or (CₙH₂ₙ₊₁) groups can be linear or branched.

As aldehyde- and keto-functional monomer units, preference is given to acrolein, vinyl acetoacetate or allyl acetoacetate, acetoacetylated hydroxyalkyl (meth)acrylates, e.g. acetoacetoxyethyl acrylate, acetoacetoxyethyl methacrylate, diacetoneacrylamide and vinyl methyl ketone in the preparation of the copolymers used according to the invention. The amount of these functional comonomers is preferably from 0.1 to 15% by weight, particularly preferably from 0.5 to 10% by weight, in particular more than 2% by weight, based on the total weight of the polymer.

Possible base monomers for the copolymers used according to the invention are known vinyl esters, in particular vinyl esters of linear and branched monocarboxylic acids, preferably those having from 2 to 15 carbon atoms. Examples are vinyl acetate, vinyl propionate, vinyl butyrate, vinyl pivalate, vinyl-2-ethylhexanoate, vinyl laurate, vinyl ester of ®Versatic acid 9, 10 or 11 (α,α′-dialkyl-branched monocarboxylic acids, trade name ®VeoVa, manufacturer: Resolution).

In addition, vinylaromatics, preferably styrene, methylstyrene or vinyltoluene, are likewise suitable as base monomers.

Fumaric and maleic monoesters and diesters are also suitable as base monomers; preference is here given to esters of monohydric aliphatic alcohols having from 1 to 12 carbon atoms, for example their diethyl, diisopropyl, dibutyl, dihexyl and dioctyl esters.

Further suitable base monomers are methacrylic and acrylic esters, in particular of linear and branched alcohols, preferably those having from 1 to 12 carbon atoms. Particular preference is given, for example, to methyl acrylate, ethyl acrylate, butyl acrylate, 2-ethylhexyl acrylate and also methyl methacrylate, ethyl methacrylate, butyl methacrylate and 2-ethylhexyl methacrylate.

The copolymers used according to the invention can comprise methacrylic or acrylic esters which are modified with epoxide groups or hydroxyl groups, preferably glycidyl methacrylate, hydroxyethyl methacrylate, hydroxyethyl acrylate, hydroxypropyl acrylate, hydroxypropyl methacrylate. The proportion of these comonomers can be from 0 to 5% by weight, preferably from 0 to 2% by weight, based on the total amount of monomers used.

The copolymers used according to the invention can further comprise, in addition to the monomer units described, monounsaturated or polyunsaturated olefinic compounds such as (C₂-C₁₂)-olefins, preferably (C₂-C₁₂)-α-olefins, for example ethylene, propylene, isobutylene, (C₃-C₁₂)-dienes, for example butadiene, isoprene, vinyl ethers, for example vinyl ethyl ether, vinyl n-butyl ether, and acrylonitrile, methacrylonitrile, vinyl chloride, N-vinylpyrrolidone.

If desired, further functional comonomers can be copolymerized. Examples of such comonomers are comonomers selected from the group consisting of ethylenically unsaturated monocarboxylic and dicarboxylic acids, their anhydrides and amides, e.g. fumaric and maleic acids and acrylic and methacrylic acids and also their anhydrides and amides, e.g. acrylamide, methacrylamide, N-methylolacrylamide, N-methylolmethacrylamide and their isobutoxy ethers or n-butoxy ethers, ethylenically unsaturated sulfonic acids or their salts, e.g. 2-acrylamido-2-methylpropanesulfonate and vinylsulfonic acid. The proportion of these comonomers is from 0 to 2% by weight, preferably from 0 to 1% by weight, based on the total amount of monomers used.

Furthermore, it is possible for monomer units containing silicon, for example acryloxypropyltri(alkoxy)silanes and methacryloxypropyltri(alkoxy)silanes, vinyltrialkoxysilanes, for example vinyltrimethoxysilane, vinyltriethoxysilane, to be present in the copolymers in an amount of from 0 to 2% by weight, preferably from 0 to 1% by weight, based on the total amount of monomers used.

Further suitable comonomers include multiply ethylenically unsaturated monomers such as divinyl adipate, divinylbenzene, vinyl acrylate, vinyl methacrylate, allyl acrylate, allyl methacrylate, diallyl maleate and diallyl fumarate, diallyl phthalate, methylenebisacrylamide, ethylene glycol diacrylate, propylene glycol diacrylate, 1,3- and 1,4-butylene diacrylate, 1,6-hexandiol diacrylate and glyceryl triacrylate.

As copolymers comprising the abovementioned aldehyde- and keto-functional monomers, particular preference is given to those listed below:
Vinyl ester-ethylene copolymers having an ethylene content of from 1 to 60% by weight, preferably an ethylene content of from 5 to 50% by weight, with vinyl esters present preferably being vinyl acetate and/or the vinyl ester of Versatic acid and/or one or more of the abovementioned monomers from the group consisting of vinyl esters, in particular vinyl pivalate, vinyl 2-ethylhexanoate, vinyl laurate.
Vinyl ester-ethylene-(meth)acrylic ester copolymers having an ethylene content of from 1 to 40% by weight, with vinyl esters present being one or more of the abovementioned monomers from the group consisting of vinyl esters, in particular vinyl acetate and the vinyl ester of Versatic acid, together with from 0.1 to 30% by weight of (meth)acrylic esters of one or more of the abovementioned monomers from the group consisting of (meth)acrylic esters, preferably methyl methacrylate, n-butyl acrylate, 2-ethylhexyl acrylate.
Vinyl acetate copolymers containing from 0 to 60% by weight of one or more of the abovementioned monomers from the group consisting of vinyl esters, with preference being given to vinyl propionate, vinyl butyrate, vinyl pivalate, vinyl 2-ethylhexanoate and the vinyl ester of Versatic acid.
Vinyl ester-(meth)acrylic ester copolymers comprising from 20 to 90% by weight of vinyl esters, with preference being given to vinyl propionate, vinyl butyrate, vinyl pivalate, vinyl 2-ethylhexanoate and the vinyl ester of Versatic acid, and from 0.1 to 50% by weight of one or more of the abovementioned monomers from the group consisting of (meth)acrylic esters, preferably methyl methacrylate, n-butyl acrylate, 2-ethylhexyl acrylate.
Vinyl ester copolymers with esters of fumaric or maleic acid, e.g. their diethyl, diisopropyl, dibutyl, dihexyl and dioctyl esters, in particular vinyl acetate copolymers with from 10 to 70% by weight of one or more of the abovementioned fumaric or maleic ester monomers, which may, if desired, further comprise additional vinyl esters such as the vinyl ester of Versatic acid or vinyl laurate, and ethylene.
(Meth)acrylic ester copolymers based on one or more of the abovementioned monomers from the group consisting of (meth)acrylic esters, with methyl methacrylate, n-butyl acrylate and 2-ethylhexyl acrylate preferably being present.
Styrene-(meth)acrylic ester copolymers having a styrene content of from 0.1 to 70% by weight, with preferred (meth)acrylic esters being methyl methacrylate and/or n-butyl acrylate and/or 2-ethyl acrylate.
Styrene-butadiene copolymers having a styrene content of from 1 to 70% by weight.
Vinyl chloride copolymers with the-abovementioned vinyl esters and/or ethylene and/or (meth)acrylates.

The copolymers mentioned are preferably prepared by the emulsion polymerization process. The polymerization can be carried out batchwise or continuously, with or without the use of seed latices, with all constituents or individual constituents of the reaction mixture being initially charged, or by the feed stream process without an initial monomer charge or with part of the monomers being initially charged in open reaction vessels or pressure vessels. The aldehyde- and keto-functional monomers may, if desired, also be added or metered in only after a conversion of from 80 to 00% by weight of the main monomers according to the invention. All amounts added preferably correspond to the consumption of the respective component. Preference is given to the seed latex process. Here, part of the total amount of monomers (in general from 1 to 20%) is initially charged and, after addition of part of the total amount of initiator (in general from 5 to 30%), prepolymerized as seed latex.

The remainder of the monomer mixture and the remaining initiator solution are then slowly metered in.

The polymerization is preferably carried out in a temperature range from 0 to 100° C. and initiated using the methods customarily employed for emulsion polymerization. If gaseous comonomers such as ethylene or vinyl chloride are used, the polymerization is carried out under super atmospheric pressure, in general from 2 to 100 bar. In the case of ethylene, the copolymers used according to the invention can also be obtained in a multistage, preferably 2-stage, polymerization process, with the copolymer either having a first ethylene-rich phase and a last low-ethylene phase or converse phases. Initiation is carried out by means of the customary, at least partially water-soluble free-radical formers which are preferably used in amounts of from 0.01 to 3.0% by weight, based on the total weight of the monomers. To stabilize the copolymers used according to the invention, it is possible to use all emulsifiers and/or protective colloids customarily used in emulsion polymerization.

Suitable protective colloids include partially hydrolyzed and fully hydrolyzed polyvinyl alcohols. The degree of polymerization of the polyvinyl alcohols is preferably from 200 to 3500, in particular from 500 to 3000. The degree of hydrolysis is preferably from 80 to 98 mol %, more preferably from 85 to 95 mol %. Also suitable are partially hydrolyzed, hydrophobically modified polyvinyl alcohols which have a degree of hydrolysis of from 80 to 98 mol % and are obtainable by copolymerization of vinyl acetate with hydrophobic comonomers, e.g. the vinyl ester of Versatic acid, vinyl laurate, vinyl chloride, ethylene, and subsequent hydrolysis or by polymer-analogous reaction of unmodified polyvinyl alcohol with diketene, acetoacetic acid or acetalyation agents such as C₁- to C₄-aldehydes, preferably butyraldehyde. The proportion of hydrophobic units is from 0.1 to 10% by weight, based on the total weight of the polyvinyl alcohol. The polyvinyl alcohols can also have been functionalized by sulfonic acid, carboxyl and/or amino groups. It is also possible to use mixtures of the polyvinyl alcohols mentioned. The amount of polyvinyl alcohol is from 1 to 20% by weight, based on the total weight of monomers used, and is generally added in the polymerization. The protective colloid can either all be initially charged or be partly charged initially and partly metered in.

Further examples of suitable protective colloids are etherified cellulose derivatives, for example hydroxyethylcellulose, methylcellulose, methylhydroxyethylcellulose, methylhydroxypropylcellulose, carboxymethylcellulose, water-soluble starches or starches degraded by hydrolysis and also polyvinylpyrrolidone, polycarboxylic acids, such as poly(meth)acrylic acid, water-soluble copolymers based on (meth)acrylic acid, e.g. acrylic acid/acrylamide and (meth)acrylic acid/(meth)acrylic ester copolymers, poly(meth)acrylamide, polyvinylsulfonic acids, styrene-maleic acid copolymers or casein, gum arabic, lignosulfonates and sodium alginate.

Examples of emulsifiers are nonionic and ionic emulsifiers which are generally used as costabilizers and are initially charged prior to the polymerization. They can be present in an amount of up to 3% by weight, based on the total mass of monomers. Nonionic emulsifiers used are, for example, ethoxylation products of propylene oxide; or alkyl polyglycol ethers such as the ethoxylation products of lauryl, oleyl, stearyl or coconut fatty alcohol, alkylphenol polyglycol ethers such as the ethoxylation products of octylphenol or nonyl phenol, diisopropyl phenol, triisopropylphenol or of di- or tri-tert-butylphenol. Possible ionic emulsifiers are first and foremost anionic emulsifiers. Use is here made of the alkali metal or ammonium salts of alkylsulfonic, arylsulfonic or alkylarylsulfonic acids, and also the corresponding sulfates, phosphates or phosphonates, which can also contain oligoethylene oxide or polyethylene oxide units between the hydrocarbon radical and the anionic group. Typical examples are sodium lauryl sulfate, sodium octylphenol glycol ether sulfates, sodium dodecylbenzenesulfonate, sodium lauryl diglycol sulfate, ammonium-tri-tert-butylphenol pentaglycol sulfate or octaglycol sulfate.

As free-radical formers for the polymerization of the comonomers, it is possible to use all free-radical-forming polymerization initiators in the customary amounts. Suitable initiators are, for example, alkali metal and ammonium salts of peroxyacids, e.g. potassium, sodium and ammonium persulfate, and also redox catalysts, for example combinations of sodium persulfate and sodium sulfite or hydrogen peroxide and ascorbic acid or hydrogen peroxide and iron(II) salts, and also tert-butyl hydroperoxide and sodium formaldehydesulfoxylate. It is also possible to use organic peroxides, percarbonates and azo compounds, preferably dibenzoyl peroxide, azobisisobutyronitrile, 2,2′-azobis(2-methylpropionamidine) dihydrochloride, tert-butyl peroxydiethylacetate and tert-butyl peroxy-2-ethylhexanoate. The amount of initiators used is from 0.1 to 2% by weight, preferably from 0.1 to 1% by weight, based on the monomers. The initiators described can also be used in admixture.

The molecular weight of the copolymers can be controlled by addition of regulating substances during the polymerization. Examples of such regulators are n-dodecyl and tert-dodecyl mercaptan, mercaptopropionic acid and its esters, isopropanol. If regulating substances are used, they are usually introduced in amounts of from 0.01 to 0.5% by weight, based on the monomers.

In addition, customary additives, for example antifoams, can be added in the polymerization. Suitable antifoams are, for example, those based on silicones or hydrocarbons.

The particle size of the polymer particles of the copolymers used according to the invention in the dispersion form is in the range from 0.02 to 15 μm, preferably in the range from 0.1 to 12 μm. The solids content of the dispersions is preferably from 40 to 65% by weight, particularly preferably from 45 to 60% by weight.

The copolymers can have a glass transition temperature in the range from −50 to +60° C., preferably from −40 to +40° C.

The dispersion powders used according to the invention are preferably prepared by means of spray drying in customary spray drying units, with atomization being able to be carried out by means of single-fluid, two-fluid or multifluid nozzles or by means of a rotary disc. The outlet temperature is generally selected in the range from 50 to 100° C., preferably from 60 to 90° C., depending on the unit, glass transition temperature of the copolymer and the desired degree of drying. To carry out spray drying, the dispersion of the copolymer, if appropriate together with protective colloids, is sprayed and dried. As protective colloids, preference is given to adding from 0 to 20% by weight of the abovementioned protective colloid polymers, based on the copolymer, in the form of an aqueous solution prior to spray drying.

To improve the storage stability and the powder flow of the dispersion powder, one or more anticaking agents are preferably introduced in parallel to the dispersion into the spray dryer, so that a preferred deposition of the anticaking agent on the dispersion particles occurs. The powder obtained can have a content of anticaking agent of up to 30% by weight, preferably up to 22% by weight, based on the total weight of polymeric constituents. Examples of anticaking agents are silica, talc, calcium carbonate or magnesium carbonate, kaolins and silicates having mean particle sizes in a preferred range from 0.1 μm to 100 μm.

To improve use properties, further additives such as pigments, fillers, foam stabilizers, hydrophobicizing agents, catalysts, rheology modifiers, e.g. leveling agents and thickeners, adhesion promoters, plasticizers, coalescing agents, emulsifiers, cement setting accelerators and retarders can be added before or during spraying.

The dispersion powders described are particularly advantageous in the production of composite thermal insulation systems comprising polymer foams, preferably in the form of expanded polystyrene boards, for thermal insulation.

To produce the thermal insulation adhesives and reinforcing mortars, the dispersion powders are homogenized with further formulation constituents such as fillers, cements and further aggregates in suitable mixers. Preference is given to preparing a dry mix and adding this to the make-up water required for processing immediately before application. The dispersion powders used according to the invention are also suitable for use in formulations for cement-free thermal insulation adhesives and reinforcing compositions.

Preferred adhesives comprise from 5 to 80% by weight of fillers such as silica sand and/or calcium carbonate or magnesium carbonate and/or lightweight fillers such as perlite and expanded clay, from 5 to 80% by weight of mineral binders such as cement and/or Ca(OH)₂, from 0.5 to 50% by weight of dispersion powders stabilized with protective colloids, from 0.1 to 2% by weight of thickeners such as cellulose ethers, polyacrylates and sheet silicates and, if desired, further additives to improve the application properties such as mechanical strength, processability, open time and water resistance.

The following examples serve to illustrate the invention. The parts and percentages reported are by weight, unless indicated otherwise.

### EXAMPLES

The examples and comparative examples were carried out in a 30 l pressure autoclave which was provided with jacket cooling and had a permitted pressure range up to 60 bar.

The viscosity of the dispersions was determined using a Haake rotational viscosimeter (Rheomat® VT 500) at a shear rate of D=386.6 s₋₁.

The particle size distribution was determined by means of a combined laser diffraction and laser scattering method (Master-Sizer Micro Plus; polydisperse Mie-evaluation; index of refraction of vinyl acetate/ethylene copolymers n_{D}²⁰=1.456; manufacturer: Malvern).

The glass transition temperatures were determined by DSC on a Perkin-Elmer 7 unit at a heating rate of 20K/min.

### Example 1

An aqueous solution comprising 1200 g of polyvinyl alcohol having a viscosity of the 4% strength aqueous solution at 20° C. of about 4 mPa·s and a degree of hydrolysis of about 88 mol %, 39.0 g of anhydrous sodium acetate, 11.1 g of sodium lauryl sulfate, 29.0 g of ®Genapol PF20 (manufacturer: Clariant) and 11 700 g of water is placed in a 30 l pressure reactor provided with a temperature regulator and stirrer. The reactor is flushed with nitrogen and ethylene to remove essentially all oxygen. The stirrer is subsequently set to 120 rpm, and 900 g of vinyl acetate and 20.8 g of acetoacetoxyethyl methacrylate are added to the mixture. After the contents of the vessel have been heated to 70° C., a solution of 1.8 g of sodium persulfate in 90 g of water is added quickly and the temperature is increased to 80° C. While the mixture is being heated up, ethylene is introduced to a pressure of 35 bar.

After the reaction has started, the parallel metered addition of 10 363 g of vinyl acetate and 239.2 g of acetoacetoxyethyl methacrylate (monomer mixture) and an initiator solution composed of 14.2 g of sodium persulfate and 713 g of water over a period of 4 hours at an internal temperature of 80° C. and an ethylene pressure of 35 bar is commenced. Three hours after commencement of the metered addition, the introduction of ethylene is stopped. After the metered addition is complete, a solution of 1.8 g of sodium persulfate in 90 g of water is added quickly. The mixture is then maintained at a temperature of 80° C. for a further 60 minutes. The mixture is subsequently cooled to room temperature.

Characteristic data:

Solids: 51.0%

pH: 4.9

Viscosity: 1080 mPa·s

Particle size distribution: 0.1 to 20 μm; d_{w}=1.42 μm; d_{w}/dₙ=10.1

Glass transition temperature: 17° C.

1000 parts of the dispersion containing carbonyl groups are admixed with 116 parts of a 25% strength polyvinyl alcohol solution (viscosity of the 4% strength solution about 4 mPa·s, degree of hydrolysis of about 88 mol %) while stirring and the mixture is subsequently spray dried as described below.

### Example 2

An aqueous solution comprising 1200 g of polyvinyl alcohol having a viscosity of the 4% strength aqueous solution at 20° C. of about 4 mPa·s and a degree of hydrolysis of about 88 mol %, 39.0 g of anhydrous sodium acetate, 11.1 g of sodium lauryl sulfate, 29.0 g of ®Genapol PF20 (manufacturer: Clariant) and 11 700 g of water is placed in a 30 l pressure reactor provided with a temperature regulator and stirrer. The reactor is flushed with nitrogen and ethylene to remove essentially all oxygen. The stirrer is subsequently set to 120 rpm, and 900 g of vinyl acetate and 31.2 g of acetoacetoxyethyl methacrylate are added to the mixture. After the contents of the vessel have been heated to 70° C., a solution of 1.8 g of sodium persulfate in 90 g of water is added quickly and the temperature is increased to 80° C. While the mixture is being heated up, ethylene is introduced to a pressure of 35 bar.

After the reaction has started, the parallel metered addition of 10 363 g of vinyl acetate and 358.8 g of acetoacetoxyethyl methacrylate (monomer mixture) and an initiator solution composed of 14.2 g of sodium persulfate and 713 g of water over a period of 4 hours at an internal temperature of 80° C. and an ethylene pressure of 35 bar is commenced. Three hours after commencement of the metered addition, the introduction of ethylene is stopped. After the metered addition is complete, a solution of 1.8 g of sodium persulfate in 90 g of water is added quickly. The mixture is then maintained at a temperature of 80° C. for a further 60 minutes. The mixture is subsequently cooled to room temperature.

Characteristic data:

Solids: 51.1%

pH: 5.0

Viscosity: 840 mPa·s

Particle size distribution: 0.1 to 20 μm; d_{w}=1.78 μm; d_{w}/dₙ=12.7

Glass transition temperature: 18° C.

1000 parts of the dispersion containing carbonyl groups are admixed with 116 parts of a 25% strength polyvinyl alcohol solution (viscosity of the 4% strength solution about 4 mPa·s, degree of hydrolysis of about 88 mol %) while stirring and the mixture is subsequently spray dried as described below.

### Example 3

An aqueous solution comprising 1200 g of polyvinyl alcohol having a viscosity of the 4% strength aqueous solution at 20° C. of about 4 mPa·s and a degree of hydrolysis of about 88 mol %, 39.0 g of anhydrous sodium acetate, 11.1 g of sodium lauryl sulfate, 29.0 g of ®Genapol PF20 (manufacturer: Clariant) and 11 700 g of water is placed in a 30 l pressure reactor provided with a temperature regulator and stirrer. The reactor is flushed with nitrogen and ethylene to remove essentially all oxygen. The stirrer is subsequently set to 120 rpm, and 900 g of vinyl acetate and 31.2 g of diacetoneacrylamide are added to the mixture. After the contents of the vessel have been heated to 70° C., a solution of 1.8 g of sodium persulfate in 90 g of water is added quickly and the temperature is increased to 80° C. While the mixture is being heated up, ethylene is introduced to a pressure of 35 bar.

After the reaction has started, the parallel metered addition of 10 363 g of vinyl acetate and 358.8 g of diacetoneacrylamide (monomer mixture) and an initiator solution composed of 14.2 g of sodium persulfate and 713 g of water over a period of 4 hours at an internal temperature of 80° C. and an ethylene pressure of 35 bar is commenced. Three hours after commencement of the metered addition, the introduction of ethylene is stopped. After the metered addition is complete, a solution of 1.8 g of sodium persulfate in 90 g of water is added quickly. The mixture is then maintained at a temperature of 80° C. for a further 60 minutes. The mixture is subsequently cooled to room temperature.

Characteristic data:

Solids: 53.2%

pH: 4.6

Viscosity: 698 mPa·s

Particle size distribution: 0.1 to 20 μm; d_{w}=0.87 μm; d_{w}/dₙ=7.9

Glass transition temperature: 18° C.

1000 parts of the dispersion containing carbonyl groups are admixed with 116 parts of a 25% strength polyvinyl alcohol solution (viscosity of the 4% strength solution about 4 mPa·s, degree of hydrolysis of about 88 mol %) while stirring and the mixture is subsequently spray dried.

### Comparative example 1

An aqueous solution comprising 1200 g of polyvinyl alcohol having a viscosity of the 4% strength aqueous solution at 20° C. of about 4 mPa·s and a degree of hydrolysis of about 88 mol %, 39.0 g of anhydrous sodium acetate, 11.1 g of sodium lauryl sulfate, 29.0 g of ®Genapol PF20 (manufacturer: Clariant) and 8 700 g of water is placed in a 30 l pressure reactor provided with a temperature regulator and stirrer. The reactor is flushed with nitrogen and ethylene to remove essentially all oxygen. The stirrer is subsequently set to 120 rpm, and 900 g of vinyl acetate are added to the mixture. After the contents of the vessel have been heated to 70° C., a solution of 1.8 g of sodium persulfate in 90 g of water is added quickly and the temperature is increased to 80° C. While the mixture is being heated up, ethylene is introduced to a pressure of 35 bar.

After the reaction has started, the parallel metered addition of 10 363 g of vinyl acetate and an initiator solution composed of 14.2 g of sodium persulfate and 713 g of water over a period of 4 hours at an internal temperature of 80° C. and an ethylene pressure of 35 bar is commenced. Three hours after commencement of the metered addition, the introduction of ethylene is stopped. After the metered addition is complete, a solution of 1.8 g of sodium persulfate in 90 g of water is added quickly. The mixture is then maintained at a temperature of 80° C. for a further 60 minutes. The mixture is subsequently cooled to room temperature.

Characteristic data:

Solids: 58.0%

pH: 4.9

Viscosity: 3040 mPa·s

Particle size distribution: 0.05 to 20 μm; d_{w}=0.92 μm; d_{w}/dₙ=8.4

Glass transition temperature: 11° C.

1000 parts of the dispersion are admixed with 116 parts of a 25% strength polyvinyl alcohol solution (viscosity of the 4% strength solution about 4 mPa·s, degree of hydrolysis of about 88 mol %) while stirring and the mixture is subsequently spray dried as described below.

Spray Drying:

After addition of the polyvinyl alcohol solution, the appropriately modified dispersions are diluted with water to a solids contents of 40% by weight and spray dried with addition of an anticaking combination of talc and dolomite (spray dryer from Niro, inlet temperature: about 130° C., outlet temperature: about 65° C., throughput: about 1000 g of dispersion/h). The anticaking agent content is 15% by weight.

Use Testing:

The examination of the tensile bond strengths of thermal insulation adhesives was carried out in accordance with the guidelines for European technical approvals for “Auβenseitige Wärmedämm-Verbundsystem mit Putzschicht”, ETAG No. 004, March 2000 edition (hereinafter referred to as EOTA guidelines).

A premix composed of 30% of portland cement CEM I 32.5 R, 38.8% of silica sand F34, 21% of silica sand F31, 10% of calcium carbonate (particle diameter d₅₀=10 μm) and 0.2% by weight of ®Tylose MH 15002 P6 (manufacturer: Clariant) was prepared. 97 parts of premix were then premixed dry with 3 parts of the dispersion powder and mixed with about 20 parts of water by means of a stirrer at a high shear rate for 1 minute. The adhesive was subsequently applied in accordance with the EOTA guidelines, the corresponding test specimens were stored under defined conditions (see below) and the tensile bond strength between adhesive and thermal insulation material and also, in the case of wet storage, the minimum area of adhesion was/were determined. Expanded polystyrene boards were used as thermal insulation material.

Table 1 shows the results of the tensile bond strength test.

TABLE 1

| | Tensile bond strength in | | Detachment on area of | |
|---|---|---|---|---|
| | N/mm² | | adhesion, in % | |
| Example | Storage A | Storage B | Storage A | Storage B |
| Ex. 1 | 0.168 | 0.088 | 100 | 40 |
| Ex. 2 | 0.144 | 0.077 | 100 | 100 |
| Ex. 3 | 0.149 | 0.092 | 100 | 90 |
| Comparison 1 | 0.170 | 0.079 | 100 | 20 |

Storage A:
28 d at 23° C. and 50% relative atmospheric humidity
Storage B:
a) 28 d at 23° C. and 50% relative atmospheric humidity
b) 2 d storage in water
c) 2 h drying at 23° C. at 50% relative atmospheric humidity

1. The use of water-redispersible dispersion powders based on one or more copolymers which are stabilized with at least one protective colloid in the production of composite thermal insulation systems, wherein the copolymer or copolymers contain(s) monomers containing carbonyl groups.

2. The use of water-redispersible dispersion powders as claimed in the preceding claim, wherein the monomers containing carbonyl groups have at least one carbonyl group selected from the group consisting of aldehyde and keto groups.

3. The use of water-redispersible dispersion powders as claimed in either of the preceding claims, wherein the monomers containing carbonyl groups are selected from the group consisting of acrolein, vinyl acetoacetate, allyl acetoacetate, diacetoneacrylamide, vinyl methyl ketone, acetoacetylated hydroxyalkyl acrylates and acetoacetylated hydroxyalkyl methacrylates.

4. The use of water-redispersible dispersion powders as claimed in any of the preceding claims, wherein the copolymer or copolymers contain(s) from 0.1 to 15% by weight, based on the total weight of the polymer, of monomers containing carbonyl groups.

5. The use of water-redispersible dispersion powders as claimed in any of the preceding claims, wherein the copolymer or copolymers comprise(s) at least one monomer selected from the group consisting of vinyl esters, vinylaromatics, acrylic esters, methacrylic esters, fumaric esters and maleic esters as base monomer.

6. The use of water-redispersible dispersion powders as claimed in any of the preceding claims, wherein the copolymer or copolymers comprise(s), in addition to the monomers mentioned, further monomers selected from the group consisting of methacrylic and acrylic esters which are modified with epoxide groups or hydroxyl groups and the anhydrides of acrylic and methacrylic acids, the amides of acrylic and methacrylic acids and their isobutoxy ethers and n-butoxy ethers, ethylenically unsaturated monocarboxylic and dicarboxylic acids, their anhydrides and amides, ethylenically unsaturated sulfonic acids and their salts, vinylsulfonic acids, vinyl chlorides, monounsaturated or polyunsaturated olefins and acryloxypropyltri(alkoxy)silanes, methacryloxypropyltri(alkoxy)silanes, vinyltrialkoxysilanes.

7. The use of water-redispersible dispersion powders as claimed in any of the preceding claims, wherein the copolymer or copolymers is/are selected from the group consisting of
Vinyl ester-ethylene copolymers having an ethylene content of from 1 to 60% by weight,
Vinyl ester-ethylene-(meth)acrylic ester copolymers having an ethylene content of from 1 to 40% by weight and a (meth)acrylic ester content of from 0.1 to 30% by weight,
Vinyl acetate copolymers containing from 0 to 60% by weight of one or more monomers from the group consisting of vinyl esters,
Vinyl ester-(meth)acrylic ester copolymers comprising from 20 to 90% by weight of vinyl esters and from 0.1 to 50% by weight of one or more monomers from the group consisting of (meth)acrylic esters,
Vinyl ester copolymers with esters of fumaric or maleic acid, (Meth)acrylic ester copolymers based on one or more monomers from the group consisting of (meth)acrylic esters,
Styrene-(meth)acrylic ester copolymers having a styrene content of from 0.1 to 70% by weight,
Styrene-butadiene copolymers having a styrene content of from 1 to 70% by weight,
Vinyl chloride copolymers with vinyl esters and/or ethylene and/or (meth)acrylates.

8. The use of water-redispersible dispersion powders as claimed in any of the preceding claims, wherein a polyvinyl alcohol is present as protective colloid.

9. The use of water-redispersible dispersion powders as claimed in any of the preceding claims in the production of thermally insulating foam composite systems.

10. The use of water-redispersible dispersion powders as claimed in the preceding claim in the production of thermally insulating polystyrene board composite systems.

11. Adhesive comprising
from 5 to 80% by weight of fillers and/or lightweight fillers,
from 5 to 80% by weight of mineral binders,
from 0.5 to 50% by weight of dispersion powder which are stabilized with protective colloids and are used as claimed in any of claims 1 to 8 and from 0.1 to 2% by weight of thickeners.
